(19) United States
(12) Patent Application Publication
(10) Pub. No.: US 2012/0151440 A1
(43) Pub. Date: Jun. 14, 2012

(54) SOFTWARE LIBRARY RECONSTRUCTION DEVICE, SOFTWARE LIBRARY RECONSTRUCTION METHOD, AND NAVIGATION DEVICE USING THIS SOFTWARE LIBRARY RECONSTRUCTION METHOD

(76) Inventors: Takeo Sakairi, Tokyo (JP); Mitsuo Shimotani, Tokyo (JP); Makoto Mikuriya, Tokyo (JP)

(21) Appl. No.: 13/392,142

(22) PCT Filed: Nov. 9, 2009
(86) PCT No.: PCT/JP2009/005950

§ 371 Date: Feb. 24, 2012

(51) Int. Cl. G06F 9/44

(52) U.S. Cl. 717/120

(57) ABSTRACT

Disclosed is a software library reconstruction device which extracts program elements which are used for the execution of a function from among program elements which construct a general-purpose software library 2a, verifies whether or not an error is found in each of the program elements extracted thereby, optimizes a program comprised of program elements each of which the software library reconstruction device has verified does not have any error, and constructs a software library 2b which is customized to the function executed thereby by using the program elements of the program optimized thereby.

### FIELD OF THE INVENTION

The present invention relates to a software library reconstruction device for and a software library reconstruction method of extracting program elements from an existing software library to reconstruct a software library which is customized to a desired function, and a navigation device using this software library reconstruction method.

### BACKGROUND OF THE INVENTION

Patent reference 1 discloses a system which automatically separates external dependence in the hierarchical structure of object containers created by a developer by using the concepts of hierarchical encapsulation to make both a relationship between the object containers and a relationship between objects included in the object containers in another container environment be non-dense, thereby being able to improve the reusability.

Furthermore, a system described in patent reference 2 extracts a functional unit used in common from among a plurality of control bundles used for control of a plurality of systems, and reconstructs the plurality of control bundles into a single new control bundle in such away that this functional unit used in common does not overlap other functional units.

The application of the technique disclosed in patent reference 1 makes it possible to make a relationship between program elements in a general-purpose software library be non-dense to combine program elements freely.

However, the developer needs to extract program elements which implement his or her desired function to combine these program elements.

Therefore, the operation of reconstructing a software library is complicated and the knowledge about individual program elements is also required, and the application of the technique to various pieces of equipment using a software library is difficult and lacks versatility.

Furthermore, while the use of the technique disclosed in patent reference 2 makes it possible to automatically extract the program elements of a function which is common to a plurality of software libraries from among these software libraries, the program elements of a function which the user desires to extract cannot be extracted.

Therefore, the conventional system cannot reconstruct a software library which is customized to a desired function by taking into consideration, for example, an execution speed and a degree of memory usage efficiency.

The present invention is made in order to solve the above-mentioned problems, and it is therefore an object of the present invention to provide a software library reconstruction device and a software library reconstruction method capable of automatically extracting program elements from a general-purpose software library to reconstruct a software library which is customized to a desired function, and a navigation device using this software library reconstruction method.

### RELATED ART DOCUMENT

### Patent Reference

Patent reference 1: Japanese Unexamined Patent Application Publication (Translation of PCT Application) No. 2000-505919
Patent reference 2: Japanese Unexamined Patent Application Publication No. 2004-227240

### SUMMARY OF THE INVENTION

In accordance with the present invention, there is provided a software library reconstruction device including: a function executing unit for executing a function specified from among a plurality of functions by using a general-purpose software library corresponding to the plurality of functions; a program extracting unit for extracting program elements which are used for the execution of the function by the function executing unit from among program elements which construct the general-purpose software library; a program verifying unit for verifying whether or not an error is found in each of the program elements extracted by the program extracting unit; a program optimizing unit for optimizing a program comprised of program elements each of which the program verifying unit has verified does not have any error; and a program reconstructing unit for constructing a software library which is customized to the function executed by the function executing unit by using the program elements of the program which is optimized by the program optimizing unit.

The software library reconstruction device in accordance with the present invention is constructed in such a way that the function executing unit executes a function specified from among a plurality of functions by using the general-purpose software library corresponding to the plurality of functions, the program extracting unit extracts program elements which are used for the execution of the above-mentioned function from among the program elements which construct the general-purpose software library, the program verifying unit verifies whether or not an error is found in each of the program elements extracted by the program extracting unit, the program optimizing unit optimizes a program comprised of program elements each of which the program verifying unit has verified does not have any error, and the program reconstructing unit constructs a software library which is customized to the function executed by the function executing unit by using the program elements of the program which is optimized by the program optimizing unit.

Because the software library reconstruction device is constructed in this way, the software library reconstruction device can automatically extract program elements from the general-purpose software library to reconstruct a software library which is customized to any desired function. As a result, the software library reconstruction device can provide improvements in the execution speed and in the memory usage efficiency.

### BRIEF DESCRIPTION OF THE FIGURES

FIG. 1 is a block diagram showing the structure of a software library reconstruction device in accordance with Embodiment 1 of the present invention;

FIG. 2 is a view showing an example of a general-purpose software library;

FIG. 3 is a block diagram showing the hardware configuration of an information processing device to which the software library reconstruction device in accordance with the present invention is applied;

FIG. 4 is a flow chart showing a flow of the operation of the software library reconstruction device in accordance with Embodiment 1;

FIG. 5 is a view showing program elements for use in the general-purpose software library shown in FIG. 2;

FIG. 6 is a view showing an example of a functionally customized software library;

FIG. 7 is a flow chart showing a flow of a software library reconstruction process in an environment for software development;

FIG. 8 is a view showing an example of a wizard screen for selection of a function;

FIG. 9 is a view showing an example of a wizard screen for setup of execution conditions;

FIG. 10 is a view showing an example of a wizard screen for setup of conditions;

FIG. 11 is a view showing an example of a wizard screen for check of execution results;

FIG. 12 is a view showing an example of a wizard screen for presentation of causes of a failure;

FIG. 13 is a view showing a screen (example 1) for display of extracted program elements;

FIG. 14 is a view showing a screen (example 2) for display of extracted program elements;

FIG. 15 is a view showing a screen (example 3) for display of extracted program elements;

FIG. 16 is a view showing a wizard screen for check of source code errors (at the time that no error is found);

FIG. 17 is a view showing a wizard screen for check of source code errors (at the time that an error is found);

FIG. 18 is a block diagram showing the structure of a navigation device in accordance with Embodiment 2 of the present invention; and

FIG. 19 is a block diagram showing the structure of a navigation device in accordance with Embodiment 3 of the present invention.

### EMBODIMENTS OF THE INVENTION

Hereafter, in order to explain this invention in greater detail, the preferred embodiments of the present invention will be described with reference to the accompanying drawings.

### Embodiment 1

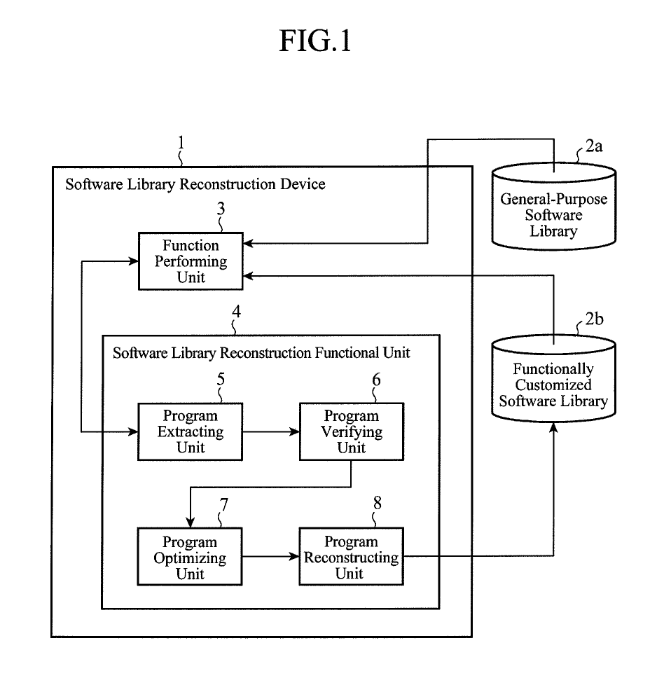

FIG. 1 is a block diagram showing the structure of a software library reconstruction device in accordance with

Embodiment 1 of the present invention. The software library reconstruction device 1 in accordance with Embodiment 1 shown in FIG. 1 is constructed in such a way as to reconstruct a functionally customized software library 2b which is customized to a desired function by using program elements extracted from a general-purpose software library 2a, and includes a function executing unit 3 and a software library reconstruction functional unit 4. Program elements include functions for use in a program and their attributes, classes for classifying these program elements, packages, and methods.

In the general-purpose software library 2a, various program elements for implementing a predetermined function are registered while being brought into correspondence to each of various pieces of application software using the predetermined function.

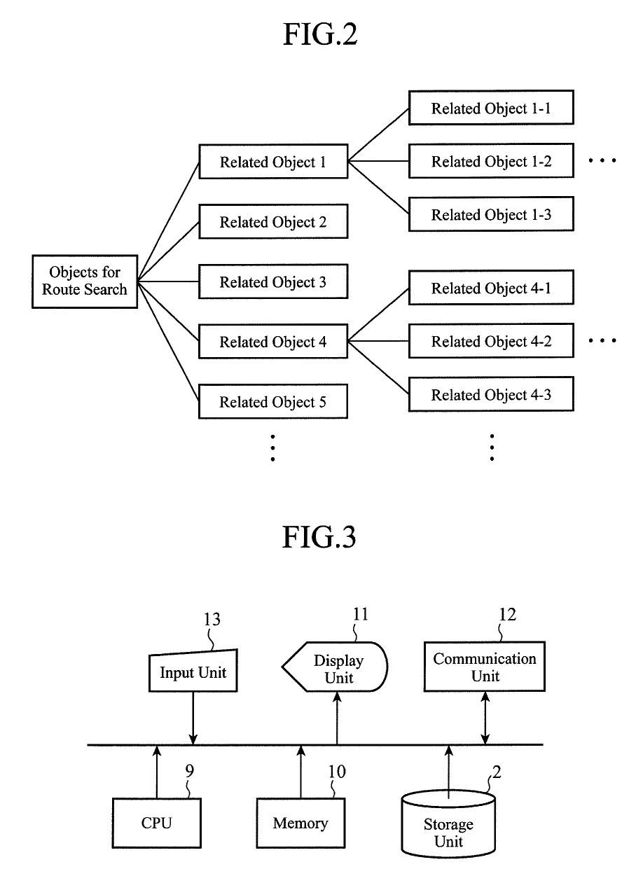

For example, the general-purpose software library 2a shown in FIG. 2 implements a route searching function in navigation processing. As shown in FIG. 2, objects for route search have a hierarchical structure which consists of related objects (program elements) each of which implements one of various functions in a route search.

Hereafter, it is assumed that when performing a route searching function, a certain type of navigation software executes related objects 1 and 4 and related objects 1-1, 1-3, and 4-2 which implement functions related to the related objects 1 and 4, for example.

On the other hand, it is assumed that when performing a route searching function, another type of navigation software executes related objects 1 and 4, which are different from the above-mentioned related objects, and related objects 1-2, 4-1, and 4-3 which implement functions related to the related objects 1 and 4.

In order to provide the general-purpose software library 2a with general versatility to two or more types of application software in this way, in addition to a group of program elements executed by a certain type of application software, program elements executed by another type of application software are also registered in the general-purpose software library 2a.

Furthermore, it is necessary to select and execute related objects (program elements) for implementing a predetermined function in each hierarchical layer from the general-purpose software library 2a.

For example, when the related objects 1 and 4, and the related object 1-1, 1-3, and 4-2 which implement the functions related to the related objects 1 and 4 are executed in order to implement the route searching function as shown in FIG. 2, a process of selecting the related objects 1 and 4 in the first hierarchical layer of the general-purpose software library 2a, and then selecting the related objects 1-2, 4-1, and 4-3 in the second hierarchical layer is carried out.

As a result, the general-purpose software library 2a reduces the memory usage efficiency by an amount required to store various program elements which implement predetermined functions. Furthermore, because the general-purpose software library requires the process of selecting desired program elements in each hierarchical layer, there is a limit in an improvement in the execution speed of each predetermined function.

The functionally customized software library 2b is reconstructed only for program elements each of which is customized to a predetermined function. For example, when a navigation device to which the software library reconstruction device 1 is applied executes the related objects 1 and 4 shown in FIG. 2 and the related objects 1-1, 1-3 and 4-2 shown in FIG. 2 which implement the functions related to the related objects and 4 in performing a route search, the functionally customized software library 2b is reconstructed only for the related objects 1 and 4, and 1-1, 1-3 and 4-2.

The function executing unit 3 is a component which, when application software using a predetermined function is executed by an information processing device to which the software library reconstruction device 1 is applied, executes the program elements which implement the above-mentioned predetermined function, among the program elements stored in the general-purpose software library 2a, or executes the program elements of the functionally customized software library 2b reconstructed by the software library reconstruction functional unit 4. For example, the above-mentioned information processing device embodies the function executing unit by executing a program module for implementing each function in navigation software.

The software library reconstruction functional unit 4 is a component for reconstructing a functionally customized software library 2b which is customized to a desired function by using program elements acquired from the general-purpose software library 2a, and includes a program extracting unit 5, a program verifying unit 6, a program optimizing unit 7, and a program reconstructing unit 8.

The program extracting unit 5 is a component which, when the function executing unit 3 performs a predetermined function, extracts the program elements which the function executing unit 3 has used from among the program elements stored in the general-purpose software library 2a. For example, when the function executing unit 3 performs a function, the program extracting unit 5 monitors and stores the path in the hierarchical layer to which each related object (program element) of the general-purpose software library 2a which is used by the function executing unit 3 belongs to extract the related object on this path from the general-purpose software library 2a. The program extracting unit 5 carries out the extraction of each related object which is used by the function executing unit 3 from the general-purpose software library 2a which is used when the predetermined function is performed by the function executing unit by monitoring either a program element for which processed data used when the predetermined function is performed is stored or a program element which is used for the process execution on the basis of the above-mentioned processed data.

The program verifying unit 6 is a component for verifying each program element extracted by the program extracting unit 5 and a relation between program elements extracted by the program extracting unit 5. For example, the program verifying unit determines whether or not an error is found in the source code of each extracted program element, and makes a comparison between program elements to find out an identical program logic in program elements. The program verifying unit verifies each extracted program element by determining whether this extracted program element meets the programming language specifications which define the specifications of this program element. For example, when an illegal code is mixed into an extracted program element, the program verifying unit determines the illegal code as an error code. Furthermore, in program optimization which is carried out by the program optimizing unit 7 which will be mentioned below, the program verifying unit compares each extracted program element with specifications which are defined for a recommended program description method to verify the program element from the viewpoint of program management, e.g. a double definition of a program element and an improvement in the readability.

The program optimizing unit 7 is a component for optimizing a relation between program elements extracted by the program extracting unit 5 and a procedure of each program element extracted by the program extracting unit 5 from the viewpoint of an improvement in the execution speed, an improvement in the efficiency of the process, etc. according to the verification results acquired by the program verifying unit 6. The program optimizing unit carries out this optimization process in view of both program element management including a double definition of a program element and an improvement in the readability, and abilities including the execution speed and the amount of memory usage. In the optimization in view of program element management, the program optimizing unit can optimize each program element semi-automatically on the basis of the results of the verification in view of program management which is carried out by the above-mentioned program verifying unit 6. On the other hand, because the optimization in view of abilities is based on human judgment, when an identical program logic duplicately existing in a plurality of program elements is found out in a program development which is carried out through a human element, e.g. a program development in which any duplicate description of a program is not recommended, the optimization processing unit 7 automatically switches to a program into which the above-mentioned program logics are unified as a program logic to be quoted from the plurality of program elements.

The program reconstructing unit 8 is a component for constructing the functionally customized software library 2b which is customized to the above-mentioned predetermined function by using the program elements related to the predetermined function which are acquired through the processes carried out by the program verifying unit 6 and the program optimizing unit 7. After the functionally customized software library 2b is constructed, the function executing unit 3 performs the above-mentioned predetermined function by using this functionally customized software library 2b.

FIG. 3 is a block diagram showing the hardware configuration of the information processing device to which the software library reconstruction device in accordance with the present invention is applied. As this information processing device, there can be a moving object information terminal, such as a car navigation device, a mobile phone, or a PDA (Personal Digital Assistant), for example.

In a storage unit 2 shown in FIG. 3, a processing program for software library reconstruction which meets the scope of the present invention, pieces of application software for implementing processes including car navigation which are carried out by this information processing device, the general-purpose software library 2a, the functionally customized software library 2b, and data (e.g. map data) which are used in each process performed by the above-mentioned application software are stored.

As the storage unit 2, a hard disk drive unit (HDD), a storage medium, such as a CD or a DVD, and a drive device used for this storage medium, a USB (Universal Serial Bus) memory, or the like can be provided.

Each of the processing program for the above-mentioned software library reconstruction, a program of each of the above-mentioned pieces of application software, and the software libraries 2a and 2b is deployed from the storage unit 2 onto a memory 10, and is executed by a CPU 9. The CPU 9 executes the processing program for the above-mentioned software library reconstruction to implement the function executing unit 3, the program extracting unit 5, the program verifying unit 6, the program optimizing unit 7, and the program reconstructing unit 8 which are shown in FIG. 1 as concrete means in which hardware and software work in cooperation with each other.

Computation results acquired by the CPU 9 are outputted to a display unit 11 via a bus, and are displayed on the screen of the display unit. The display unit 11 performs a process of displaying a map for car navigation, or the like, for example. A liquid crystal display or a plasma display can be used as this display unit 11.

A communication unit 12 communicates with a device disposed outside the information processing device. In the case in which the information processing device is a navigation device, the communication unit receives GPS radio waves and FM radio waves.

An input unit 13 is a device which a user uses to operate the information processing device and input information. The input unit is implemented by a keyboard, control switches, a touch panel which is combined with the display unit 11, or the like. In the case in which the information processing device is a navigation device, conditions for route search are inputted by using this input unit 13.

Although the example in which all of the processing program for the above-mentioned software library reconstruction, the pieces of application software, the software libraries 2a and 2b, and the data which are used in the process performed by each of the above-mentioned pieces of application software are stored in the storage unit 2 is shown in FIG. 3, each of these pieces of software or at least one of the pieces of software can be stored in a different storage unit from which the CPU 9 can read memory contents.

Next, the operation of the information processing device will be explained.

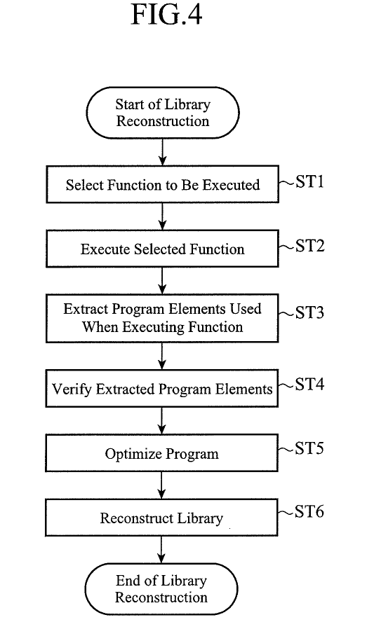

FIG. 4 is a flow chart showing a flow of the operation of the software library reconstruction device in accordance with Embodiment 1. The details of the reconstruction of a software library will be explained with reference to this flow chart.

First, a user selects a function which the user desires to cause the information processing device to perform from the existing general-purpose software library 2a (step ST1). For example, the information processing device can display a function selection screen for selection of a function on the display unit 11 so as to provide a GUI (Graphical User Interface) which enables the user to interactively select a function by using the input unit 13.

The information processing device enables the user to simultaneously select two or more functions. At this time, the information processing device causes the user to select either a mode of constructing a plurality of functionally customized software libraries 2b which are customized to a plurality of selected functions, respectively, or a mode of constructing a single functionally customized software library 2b which is customized to all of the plurality of selected functions on the above-mentioned function selection screen.

As an alternative, instead of enabling the user to select a function on the function selection screen, the information processing device can determine that a function has been selected when application software using the general-purpose software library 2a and corresponding to the function is started by the function executing unit 3. For example, when a route search is commanded while the information processing device executes the navigation software, the information processing device can determine that the route searching function has been selected.

Next, the function executing unit 3 performs a function selected in step ST1 (step ST2). The execution conditions for the execution of the function are registered in the storage unit 2 in advance. The function executing unit 3 executes the function on the above-mentioned execution conditions which are deployed from the storage unit 2 into the memory 10. For example, in the case in which the function is the route searching one, information about a database for use in the route searching function and information about an algorithm for route search are set as the execution conditions.

When the function executing unit 3 executes the function, the program extracting unit 5 extracts the program elements which the function executing unit 3 has used from the general-purpose software library 2a in turn (step ST3). For example, the program extracting unit extracts the program elements by using information, such as a class name, which can identify each of the program elements.

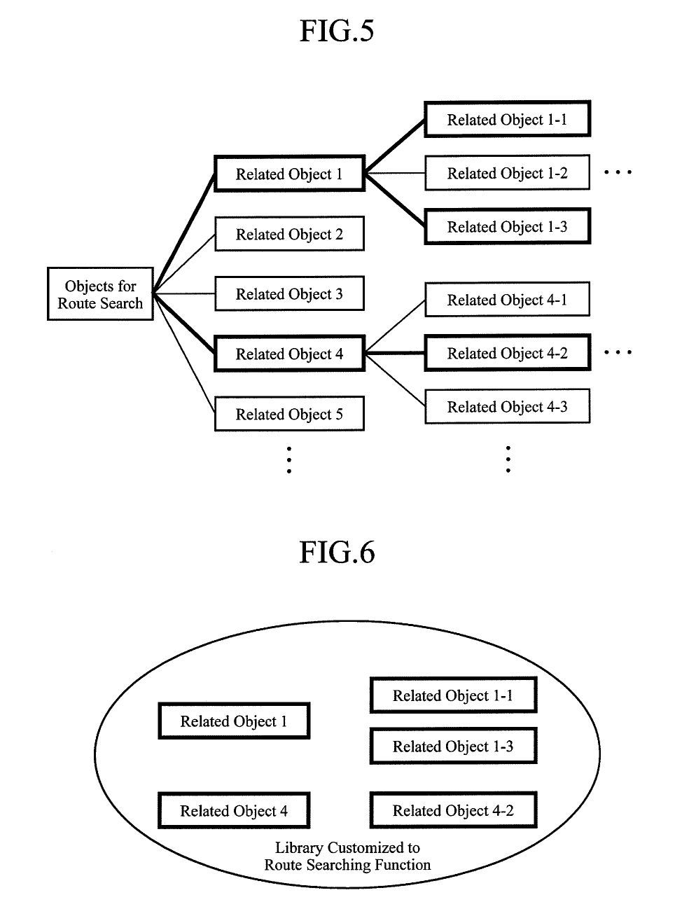

FIG. 5 is a view showing a case in which the program elements which the function executing unit 3 has used are found out from among the program elements in the general-purpose software library 2a shown in FIG. 2. As shown by thick frames and thick lines in FIG. 5, the program extracting unit 5 extracts each related object (program element) which the function executing unit 3 has used to determine the path of each related object (program element) which the function executing unit 3 has used in turn in the general-purpose software library 2a. The program elements which are extracted in the execution order by the program extracting unit 5 are outputted to the program verifying unit 6.

Next, the program verifying unit 6 verifies if an error is found in the program source code of each extracted program element while making a comparison between extracted program elements to find out an identical program logic existing in two or more program elements, and also finding out attributes and functions which are not used (step ST4).

After that, the program optimizing unit 7 optimizes a relation between extracted program elements and a procedure of each extracted program element according to the results of the verification made by the program verifying unit 6 (step ST5). For example, in order to remove the redundancy of the program which is comprised of the extracted program elements, the program optimizing unit changes the program to a program from which the unused attributes and the unused functions found out by the program verifying unit 6 are removed, and in which the duplicate program logics are unified into a single program logic.

The program reconstructing unit 8 constructs a functionally customized software library 2b which is customized to the function selected in step ST1 by using the program elements which are optimized by the program optimizing unit 7 (step ST6).

FIG. 6 is a view showing an example of the functionally customized software library, and shows the functionally customized software library 2b using related objects (program elements) shown in FIG. 5 which are determined as what are used for the route searching function. Because the program reconstructing unit reconstructs the software library which is customized to the route searching function, as shown in FIG. 6, the data size can be reduced and the memory efficiency can be improved. In addition, because the objects (program elements) which should be used are limited, an improvement in the processing speed can also be provided.

The case in which the software library reconstruction device carries out the processing in a batch including from the execution of a selected function by using the preset execution conditions to the construction of a software library which is customized to this function is shown. Hereinafter, a case in which the software library reconstruction device performs the processing interactively in a wizard form will be explained.

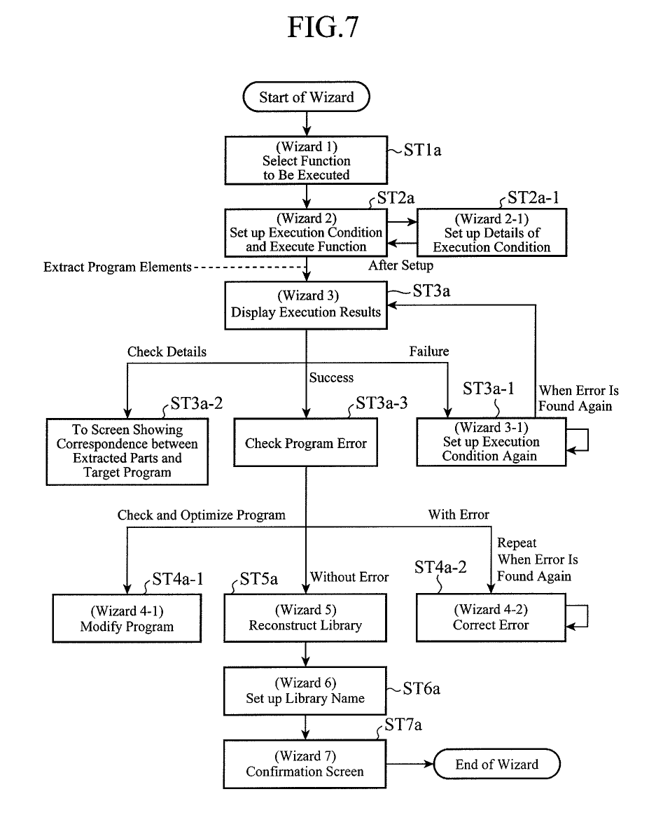

FIG. 7 is a flow chart showing a flow of the software library reconstruction processing in an environment for software development, and shows the case in which the processing is carried out in a wizard form. The environment for software development has a function of adding an arbitrary function as a plug-in, and the above-mentioned wizard can also be used as an additional function which can be added to an existing software development environment in this way.

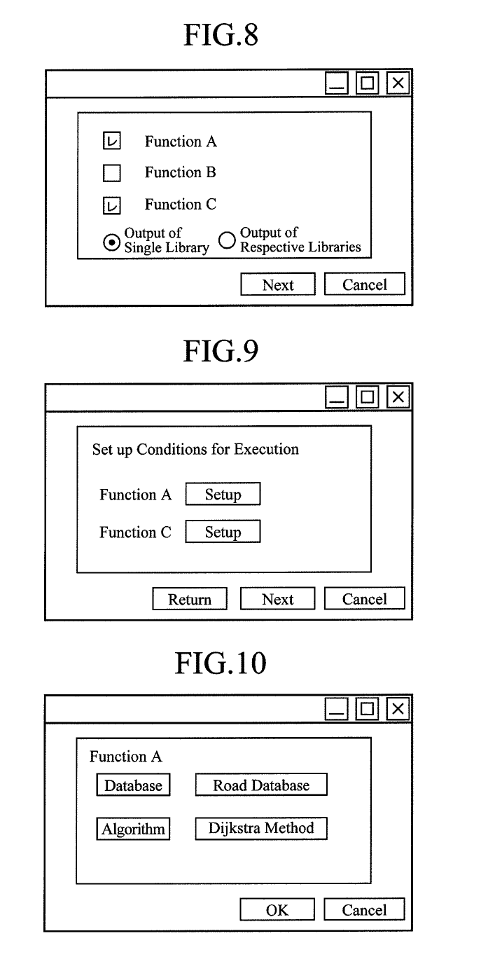

First, the function executing unit 3 displays a wizard screen for function selection as shown, for example, in FIG. 8 on the display unit 11 to inquire of the developer (user) which function the developer selects to cause the developer to interactively select one or more functions by using the input unit 13. The wizard screen for function selection displays a list of functions which are candidates for the selection, as shown in FIG. 8, so as to enable the developer to select a plurality of functions simultaneously.

Furthermore, in the wizard screen for function selection, a setting field for enabling the user to select either the mode of constructing a plurality of functionally customized software libraries 2b which are customized to a plurality of selected functions, respectively (output of respective libraries), or the mode of constructing a single functionally customized software library 2b which is customized to all of the plurality of selected functions (output of single library) is disposed.

When a function is selected on the wizard screen for function selection (step ST1a), the program extracting unit 5 displays a wizard screen for setup of execution conditions for setting up execution conditions for the selected function as shown in, for example, FIG. 9 on the display unit 11 to inquire of the developer about execution conditions. In the wizard screen for setup of execution conditions, in order to enable the developer to check one or more selected functions and to start a setup of execution conditions for each selected function, a list of the one or more selected functions is shown and setup buttons each for starting a setup of conditions corresponding to each selected function are disposed as shown in FIG. 9.

When a setup button in the wizard screen for setup of execution conditions is pushed down by using the input unit 13, the function executing unit 3 displays a wizard screen for setup of conditions which enables the user to set up the details of execution conditions as shown in, for example, FIG. 10 on the display unit 11 to inquire of the developer about the details of execution conditions, and causes the developer to interactively set up the contents of the execution conditions by using the input unit 13. In the example of FIG. 10, a case in which a setup button corresponding to a function A shown in FIG. 9 is pushed down is shown, and the developer is enabled to set up information about a database and information about an algorithm as the execution conditions. On this wizard screen for setup of conditions, the developer sets up the execution conditions for each selected function by using the input unit 13. After the execution conditions are set up for each selected function, the function executing unit 3 executes each selected function on the execution conditions. The processes which have been explained until now correspond to steps ST2a and ST2a-1.

While the function executing unit 3 executes a function, the program extracting unit 5 automatically extracts the program elements which the function executing unit 3 has used in turn from the general-purpose software library 2a.

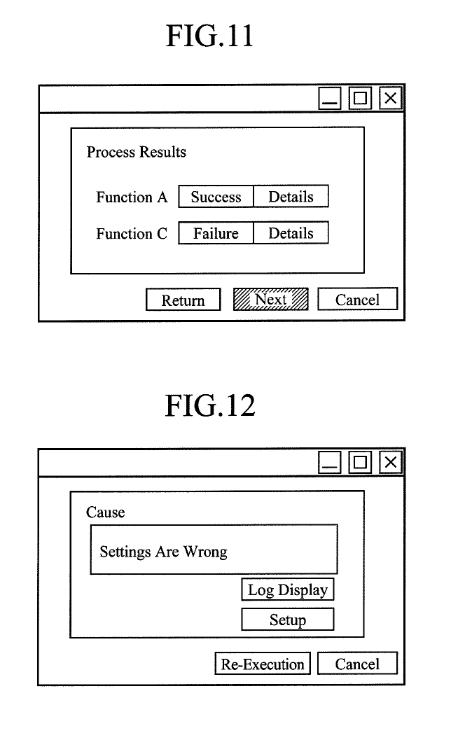

The function executing unit 3 also displays a wizard screen for check of execution results showing whether the function executing unit has succeeded in the execution of the function as shown in, for example, FIG. 11 on the display unit 11 (step ST3a). In this wizard screen for check of execution results, a detailed button showing success or failure in the execution of each selected function and the details of causes of the success or failure is disposed for each selected function, as shown in FIG. 11.

When a detailed button corresponding to a function C which the function executing unit 3 has failed to execute is pushed down on the wizard screen shown in FIG. 11, the function executing unit 3 displays a wizard screen for presentation of failure cause as shown in, for example, FIG. 12 on the display unit 11. When a log display button is pushed down on this wizard screen, the function executing unit 3 displays a log of the execution of the function on the display unit 11.

Furthermore, when a setup button is pushed down, the function executing unit 3 displays a wizard screen for setup of conditions which enables the user to set up the details of execution conditions as shown in FIG. 10 on the display unit 11 to cause the developer to set up execution conditions again (step ST3a-1).

After that, when a re-execution button is pushed down, the function executing unit 3 executes the function which the function executing unit 3 has failed to execute on the execution conditions which the function executing unit has set up again, and then returns to the process of step ST3a.

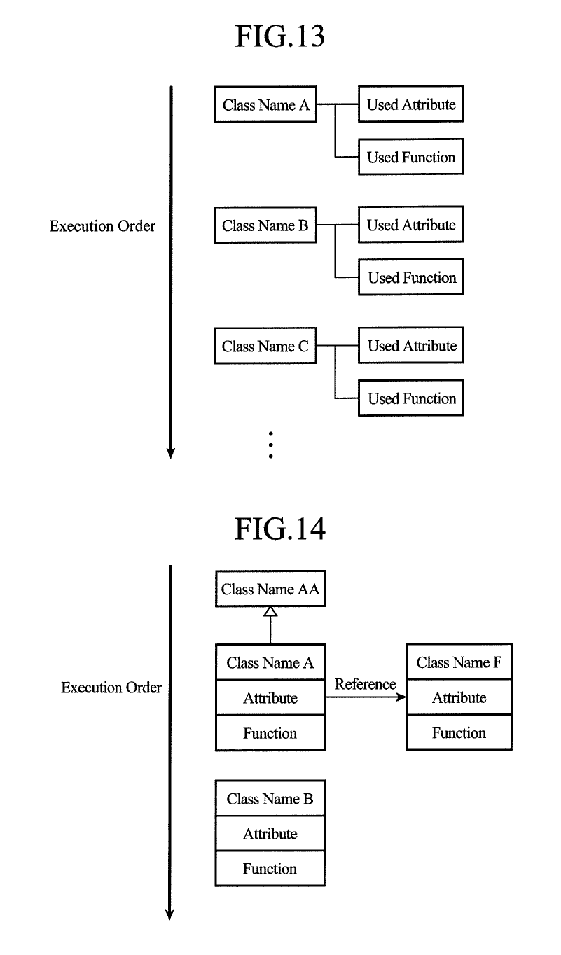

When a detailed button corresponding to the function A which the function executing unit has succeeded in executing is pushed down on the wizard screen shown in FIG. 11, the function executing unit 3 displays the program elements of the function A which are extracted by the program extracting unit 5 on the display unit 11 (step ST3a-2). For example, the function executing unit 3 can display the program elements in such a way that the order in which the function executing unit 3 executed the program elements can be known as shown in FIG. 13.

As an alternative, the function executing unit can express the program elements which are shown in the order that they were executed in UML (Unfiled Modeling Language) which is a program description language (e.g., in the form of a class figure), as shown in FIG. 14.

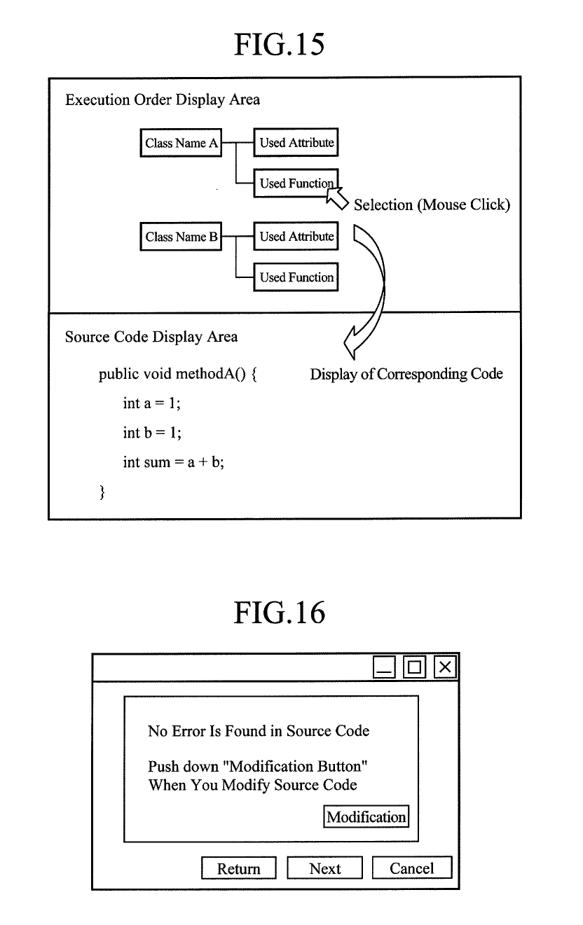

In addition, the function executing unit can provide an execution order display area in which the program elements are displayed in the order that they were executed, and a source code display area in which the source code of each program element can be displayed, as shown in FIG. 15. When a program element is selected in the execution order display area by using the input unit 13, the function executing unit 3 displays the source code corresponding to the selected program element in the source code display area.

Until the execution of every selected function succeeds, the function executing unit 3 places a “next” button on the wizard screen for check of execution results in a state in which the next button cannot be selected, as shown by hatch lines in FIG. 11. When the “next” button is pushed down, the program verifying unit 6 starts and carries out an error check on the source code of each program element extracted by the program extracting unit 5, and makes a comparison between program elements to find out an identical program logic existing in program elements, and attributes and functions which are not used (step ST3a-3).

When verifying the source code of a program element and then not finding out any error in the source code, the program verifying unit 6 displays a wizard screen for check of source code error as shown in, for example, FIG. 16 on the display unit 11. On the wizard screen for check of source code error which is created when no error is found in the source code, a modification button for modifying the source code is disposed as shown FIG. 16.

When the modification button is pushed down by using the input unit 13, the program optimizing unit 7 starts and displays a modification screen for modification to source code on the display unit 11 to inquire of the developer about required information, and then causes the developer to interactively input information used for modifying the source code of the selected program element of the function by using the input unit 13.

At this time, the program optimizing unit 7 displays a program logic existing duplicately in program elements, which is found out by the program verifying unit 6, and attribute and functions which are not used on the above-mentioned modification screen to modify the source code according to modifications made by the developer (step ST4a-1). When the modification of the source code is completed, the program verifying unit 6 carries out an error check again.

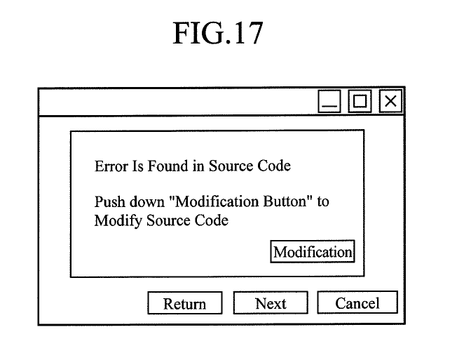

In contrast, when verifying the source code of the program element and then finding out an error in the source code, the program verifying unit 6 displays a wizard screen for check of source code error as shown in, for example, FIG. 17 on the display unit 11 to inquire of the developer about required information, and then causes the developer to interactively input modifications which the developer desires to make to the source code of the function by using the input unit 13 (step ST4a-2). A process which the program verifying unit carries out at the time that a modification button is pushed down by using the input unit 13 is the same as the above-mentioned process explained with reference to FIG. 16. The above-mentioned processes carried out by the program verifying unit 6 and the program optimizing unit 7 are repeated until no error is found in the source code of the program element.

When no error is found in the source code of each program element and the program is optimized through the modifying process, the program reconstructing unit 8 starts and displays a wizard screen for inquiring whether or not to reconstruct a software library on the display unit 11 to inquire of the developer whether or not to reconstruct a software library, and causes the developer to interactively select whether or not to reconstruct a software library by using the input unit 13 (step ST5a). At this time, when the developer makes a decision not to reconstruct a software library, the program reconstructing unit ends the process.

When the developer makes a decision to reconstruct a software library, the program reconstructing unit 8 displays a wizard screen for setup of a library name for identifying the software library reconstructed on the display unit 11 (step ST6a). When the mode of constructing a plurality of functionally customized software libraries 2b which are customized to a plurality of selected functions, respectively (output of respective libraries) has been selected on the wizard screen shown in FIG. 8, the program reconstructing unit enables the developer to set up a library name corresponding to each of the software libraries.

When a setup of one or more library names is completed, the program reconstructing unit 8 constructs a functionally customized software library 2b which is customized to each selected function or all of the selected functions by using the program elements optimized by the program optimizing unit 7. After that, the program reconstructing unit 8 displays a wizard screen for check which enables the developer to recognize that the functionally customized software library has been reconstructed on the display unit 11 (step ST7a), then stores the functionally customized software library 2b in the storage unit 2 while bringing this library into correspondence with its library name, and ends the processing.

As mentioned above, in the software library reconstruction device in accordance with this Embodiment 1, the function executing unit 3 executes a function specified from among a plurality of functions by using the general-purpose software library 2a corresponding to the plurality of functions, the program extracting unit 5 extracts the program elements used for the execution of the above-mentioned function from among the program elements which construct the general-purpose software library 2a, the program verifying unit 6 verifies whether or not an error is found in each of the program elements extracted by the program extracting unit 5, the program optimizing unit 7 optimizes a program which is comprised of program elements each of which the program verifying unit 6 has verified does not have any error, and the program reconstructing unit 8 constructs a software library 2b which is customized to the function executed by the function executing unit 3 by using the program elements of the program which is optimized by the program optimizing unit 7. Because the software library reconstruction device is constructed in this way, the software library reconstruction device can automatically extract program elements from the general-purpose software library 2a to reconstruct a software library 2b which is customized to any desired function. As a result, the software library reconstruction device can provide a software library which can provide improvements in the execution speed and in the memory usage efficiency.

Furthermore, in the software library reconstruction device in accordance with this Embodiment 1, each of the function executing unit 3, the program verifying unit 6, the program optimizing unit 7, and the program reconstructing unit 8 interactively inquires of the user (developer) about information required to perform its own process in a wizard form, and performs its own process according to the information required to perform its own process which is inputted by the user. Because the software library reconstruction device is constructed in this way, the software library reconstruction device enables the user to cause the software library reconstruction device itself to carry out the reconstructing process of reconstructing a software library according to guidance from the device specifically in a software development environment, thereby being able to improve the convenience of the reconstructing process.

In addition, in the software library reconstruction device in accordance with this Embodiment 1, each of the function executing unit 3, the program verifying unit 6, the program optimizing unit 7, and the program reconstructing unit 8 performs its own process automatically according to preset information required to perform its own process. Because the software library reconstruction device is constructed in this way, the software library reconstruction device can improve the convenience of the software library reconstruction device itself in a mounted environment in which an exchange of interactive information may cause the process to become complicated.

Although in above-mentioned Embodiment 1 the example in which a functionally customized software library 2b is reconstructed by using program elements extracted from the general-purpose software library 2a is shown, the software library reconstruction device can alternatively execute a function on execution conditions specified by the user by using program elements extracted from the functionally customized software library 2b, and can reconstruct the functionally customized software library 2b in such away that the function is further limited by the execution conditions specified by the user.

By doing in this way, the software library reconstruction device can provide improvements in the execution speed and in the memory usage efficiency.

### Embodiment 2

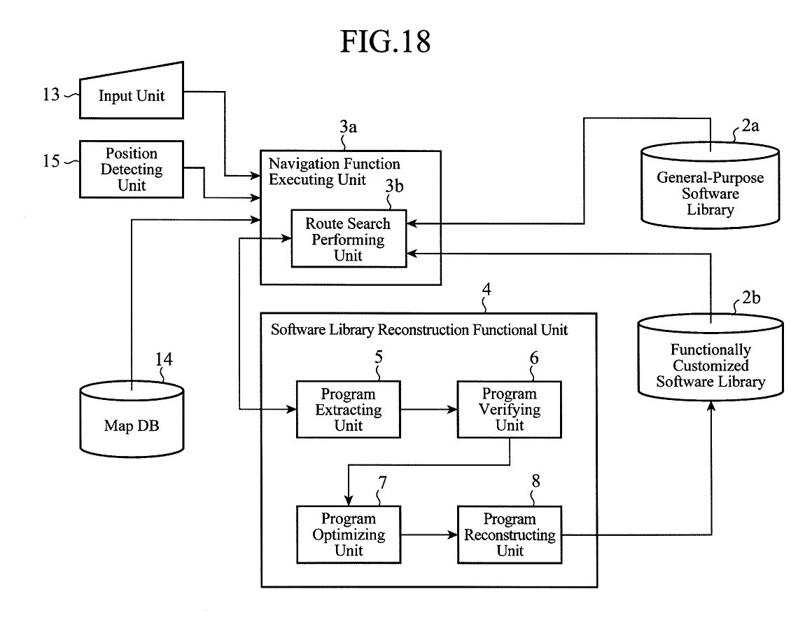

FIG. 18 is a block diagram showing the structure of a navigation device in accordance with Embodiment 2 of the present invention, and shows the structure in which a software library reconstruction device in accordance with the present invention is applied to the car navigation device. A navigation function executing unit 3a shown in FIG. 18 is a component corresponding to the function executing unit 3 shown in FIG. 1, and executes a car navigation function. In FIG. 18, a route searching function is shown as an example of the car navigation function, and any components other than a route search performing unit 3b are not shown in the navigation function executing unit.

A map database (map DB) 14 is a storage part for storing map data. For example, this map database is constructed in a storage unit as shown in FIG. 2. A position detecting unit 15 is a component for detecting the position of a vehicle in which the navigation device is mounted. For example, the position detecting unit determines the current position of the vehicle by using GPS signals, measurement values from sensors including a speed sensor and a gyro sensor, map matching, etc. In FIG. 18, the same components as those shown in FIGS. 1 and 2 are designated by the same reference numerals, and the explanation of the components will be omitted hereafter.

Next, the operation of the navigation device will be explained.

Hereafter, a case in which the navigation device executes the route searching function among the car navigation functions, and then reconstructs a functionally customized software library 2b which is customized to the route searching function will be described. First, the navigation device starts car navigation software which is executed by the navigation function executing unit 3a, inputs a destination by using the input unit 13, and commands the route search performing unit to perform a route search.

As a result, the route search performing unit 3b performs a route searching process of searching for a route to the destination by using program elements required for the route searching function acquired from a general-purpose software library 2a, map data required to perform the route search which are acquired from the map DB 14, and the position information showing the position of the vehicle which is acquired from the position detecting unit 15.

When the route search performing unit 3b performs a route search, a program extracting unit 5 determines that the route searching function has been selected and extracts the program elements which the route search performing unit 3b has used in turn from the general-purpose software library 2a. The program elements which are extracted in the order that they were executed by the program extracting unit 5 are outputted to a program verifying unit 6.

The program verifying unit 6 verifies if an error is found in the program source code of each extracted program element while making a comparison between extracted program elements to find out an identical program logic existing in two or more program elements, and also finding out attributes and functions which are not used.

After that, a program optimizing unit 7 optimizes a relation between extracted program elements and a processing procedure of each extracted program element according to the results of the verification made by the program verifying unit 6.

Finally, a program reconstructing unit 8 constructs a functionally customized software library 2b which is customized to the route searching function by using the program elements which are optimized by the program optimizing unit 7.

After reconstructing the library which is customized to the route searching function, the program reconstructing unit brings a library name into correspondence with the functionally customized software library 2b and stores this software library in a storage unit 2, and then ends the processing. As a result, the functionally customized software library 2b which is customized to the route searching function is used for the route search from the next time.

Furthermore, by repeatedly performing a process of executing the route searching function by using program elements extracted from the functionally customized software library 2b on newly set up execution conditions, and then constructing a software library 2b in such a way that the route searching function is further limited by the newly set up execution conditions by using the program elements which are used during the execution of the route searching function, the navigation device can provide improvements in the execution speed of the route searching function and in the memory usage efficiency of the software library 2b.

As mentioned above, the navigation device in accordance with this Embodiment 2 having the navigation function of searching for a route from a departure point to a destination point, and performing route guidance is provided with the navigation function executing unit 3a for executing a function which is specified from among a plurality of functions related to a navigation function by using the general-purpose software library 2a corresponding to the plurality of functions, the program extracting unit 5 for extracting program elements used for the execution of the function by the navigation function executing unit 3a from among the program elements which construct the general-purpose software library, the program verifying unit 6 for verifying whether or not an error is found in each program element extracted by the program extracting unit 5, the program optimizing unit 7 for optimizing a program which consists of program elements each of which the program verifying unit 6 has verified does not have any error, and the program reconstructing unit 8 for constructing a software library 2b which is customized to the function executed by the navigation function executing unit 3a by using the program elements of the above-mentioned program which is optimized by the program optimizing unit 7. Because the navigation device is constructed in this way, the navigation device can automatically extract program elements from the general-purpose software library 2a, and can construct a software library 2b which is customized to a desired car navigation function specified by the user. As a result, the navigation device can provide improvements in the execution speed of the car navigation process and in the memory usage efficiency in the car navigation process.

Although in above-mentioned Embodiment 2 the vehicle-mounted navigation device is shown as an example, the software library reconstruction device in accordance with the present invention can be applied to a navigation function installed in a mobile information terminal. In this variant, the same advantages can be provided. In a structure in which a server device performs a navigation process and downloads the results of the process to a mobile information terminal, the present invention can be applied to the server device. In contrast, in a case in which a mobile information terminal itself performs a navigation process, the present invention can be applied to the mobile information terminal.

### Embodiment 3

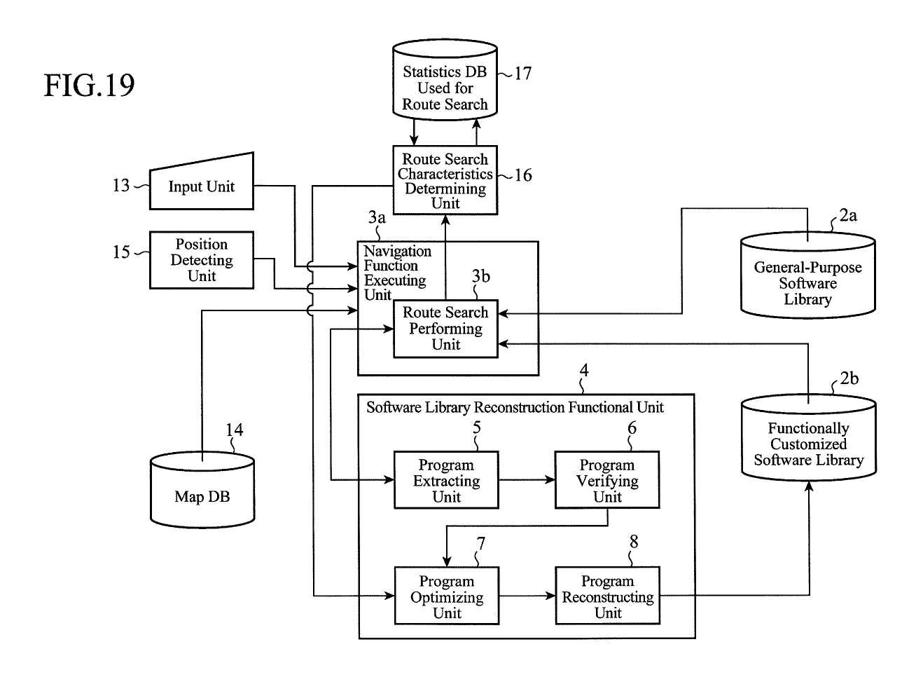

FIG. 19 is a block diagram showing the structure of a navigation device in accordance with Embodiment 3 of the present invention, and shows the structure in which a software library reconstruction device in accordance with the present invention is applied to the car navigation device. In FIG. 19, the same components as those shown in FIG. 18 are designated by the same reference numerals, and the explanation of the components will be omitted hereafter.

A route search characteristics determining unit (usage characteristics determining unit) 16 is a component for carrying out a statistical process on execution conditions (a search pattern) imposed on a route search performing unit 3b and specified by a user to determine execution conditions according to the user's usage characteristics at the time of executing a route searching function.

A search pattern is mentioned as an example of the execution conditions imposed on the router searching function. As this search pattern, there is a distance priority pattern which gives a higher priority to the distance to a destination at the time of performing a route search, or a time priority pattern which gives a higher priority to the predicted elapsed time to the destination at the time of performing a route search, for example. When the distance priority pattern is specified, the route search performing unit 3b searches for an optimal route while giving a higher priority to a route having a shorter distance to the destination, whereas when the time priority pattern is specified, the route search performing unit 3b searches for an optimal route while giving a higher priority to a route having a shorter prediction elapsed time to the destination.

Furthermore, a statistics database used for route search (statistics DB used for route search) 17 is a storage part for storing information showing execution conditions according to the usage characteristics of each user at the time of executing the route searching function which are determined for the user by the route search characteristics determining unit 16, and is constructed in a storage unit as shown in FIG. 2, for example.

Next, the operation of the navigation device will be explained.

Hereafter, an example in which the navigation device executes the route searching function among car navigation functions, and reconstructs a functionally customized software library 2b which is customized to the route searching function will be described.

First, the navigation device starts the car navigation software which is executed by a navigation function executing unit 3a, inputs a destination and a search pattern by using an input unit 13, and commands the navigation function executing unit to perform a route search.

As a result, the route search performing unit 3b performs a route searching process of searching for a route to the destination according to a search pattern by using program elements required for the route searching function acquired from a general-purpose software library 2a, map data required to perform the route search which are acquired from a map DB 14, and position information showing the position of a vehicle which is acquired from a position detecting unit 15.

When the route search performing unit 3b performs a route search, a program extracting unit 5 determines that the route searching function has been selected and extracts the program elements which the route search performing unit 3b has used in turn from the general-purpose software library 2a. The program elements which are extracted in the order that they were executed by the program extracting unit 5 are outputted to a program verifying unit 6.

The program verifying unit 6 verifies if an error is found in the program source code of each extracted program element while making a comparison between extracted program elements to find out an identical program logic existing in two or more program elements, and also finding out attributes and functions which are not used.

While the route search characteristics determining unit 16 acquires information showing the search pattern specified by the user from the route search performing unit 3b and stores the information in the statistics DB 17 used for route search, the route search characteristics determining unit reads all search patterns which were specified by the user in the past from the statistics DB 17 used for route search, and determines the user's usage characteristics at the time of executing the route searching function according to the results of having analyzed those search patterns statistically. The information showing the usage characteristics is outputted from the route search characteristics determining unit 16 to a program optimizing unit 7. For example, the route search characteristics determining unit determines the user's usage characteristics at the time of executing the route searching function by using a statistical analysis method, such as a qualification theory analysis of statistically evaluating the search patterns specified by the user with reference to qualitative and quantitative data which are collected and stored in the statistics DB 17 used for route search on a route search condition which will be mentioned below.

For a route search, a route search condition, such as a distance priority mode, a toll road priority mode, or a local street priority mode, can be set up. The route search characteristics determining unit 16 stores information showing which one of the route search conditions the user has selected, and, as information showing surrounding conditions at the time of the selection, information showing the time period during which the selection is done, traffic information acquired from VICS (registered trademark) information or the like, and information about the regional characteristics (an urban area, a rural area, a sightseeing area, or the like) of the current position in the above-mentioned statistics DB 17 used for route search.

The amount of information stored in this statistics DB 17 used for route search increases every time when the user causes the navigation device to perform a route search, and the route search characteristics determining unit specifies the route searching function which has been used most frequently from the usage characteristics of the user at the time of executing the route searching function which are analyzed on the basis of the above-mentioned information by using the statistical analysis method of determining the above-mentioned user usage characteristics, or the like and the program optimizing unit 7 extracts the program elements for implementing the specified function.

The route search characteristics determining unit 16 extracts the program elements which implement the route search condition in consideration of the user usage characteristics derived by using the above-mentioned statistics method from the program elements which construct the route searching function, like the above-mentioned program extracting unit 5, and verifies each of the above-mentioned program elements extracted by using the function of the above-mentioned program verifying unit 6 and outputs program elements to the program optimizing unit 7.

The program optimizing unit 7 optimizes a relation between extracted program elements and a processing procedure of each extracted program element according to both the results of the verification made by the program verifying unit 6 and the search pattern according to the usage characteristics of the route search which are determined by the route search characteristics determining unit 16.

A program reconstructing unit 8 constructs a functionally customized software library 2b in which the route searching function is limited according to the user's usage characteristics by using the program elements optimized by the program optimizing unit 7.

After reconstructing the library which is customized to the route searching function, the program reconstructing unit brings a library name into correspondence with the functionally customized software library 2b and stores this software library in a storage unit 2, and then ends the processing. As a result, the functionally customized software library 2b which is customized to the route searching function is used for the route search from the next time.

Furthermore, by repeatedly reconstructing a software library 2b in such a way that the route searching function is further limited by a search pattern according to the usage characteristics at the time of performing a route search by using program elements which are extracted from the functionally customized software library 2b, the navigation device can provide a software library which provides a function which satisfies the user's usage characteristics.

A software library reconstruction functional unit 4 can carry out the reconstruction process during an idle time period during which the navigation processing of the navigation function executing unit 3a is not carried out. As a result, the software library reconstruction functional unit can carry out the reconstruction process without providing any processing load on the navigation processing.

As mentioned above, the navigation device in accordance with this Embodiment 3 includes the route search characteristics determining unit 16 for acquiring an execution condition (e.g. a search pattern for route search) which is specified by a user every time when the navigation function executing unit performs the navigation function, and for carrying out a statistical process on the acquired execution condition to determine an execution condition to be imposed on the function according to the usage characteristics of the user, and the program optimizing unit 7 optimizes the program which consists of the program elements each of which the program verifying unit 6 has verified does not have any error by using the execution condition which is determined by the route search characteristics determining unit 16 and the program reconstructing unit 8 constructs a software library in which the function is limited by the execution condition which is determined by the route search characteristics determining unit 16 by using the program elements of the program which is optimized by the program optimizing unit 7. Because the navigation device in accordance with this embodiment is constructed in this way, the same advantages as those provided by above-mentioned Embodiment 2 are provided. Furthermore, because the navigation device reconstructs a software library in consideration of the user's usage characteristics, the navigation device can improve the user's convenience.

Although in above-mentioned Embodiment 3 the example in which the navigation device reconstructs a software library according to a search pattern according to the usage characteristics at the time of performing a route search is shown, the present invention is not limited to this example. As an execution condition imposed on the route searching function, the navigation device can use another execution condition which is set up by the user instead of a search pattern. Furthermore, the present embodiment can be applied to route guidance, a display of various pieces of information, or the like which is a navigation function other than the route searching function.

More specifically, the usage characteristics determining unit is constructed in such a way as to, every time when the function executing unit 3 performs a navigation function, acquire an execution condition to be imposed on the function which is specified by the user and carry out a statistical process on the acquired execution condition to determine an execution condition to be imposed on the function according to the usage characteristics of the user. In this case, even for a function which is executed by an information processing device, other than a navigation device, to which the present invention is applied, a software library in which the function is limited by an execution condition according to the user's usage characteristics can be reconstructed.

Furthermore, there rarely occurs a situation in which the user optimizes the source code when the navigation device carries out the software library reconstruction process in accordance with above-mentioned Embodiment 3 of reconstructing a software library for a navigation function.

Therefore, the navigation device can be constructed in such a way as to prepare a software library which is customized to a function corresponding to each of two or more kinds of route search conditions, and switch to a corresponding software library according to the user's usage characteristics at the time of performing a route search.

### INDUSTRIAL APPLICABILITY

Because the software library reconstruction device in accordance with the present invention automatically extracts program elements from a general-purpose software library to reconstruct a software library which is customized to a desired function, the software library reconstruction device in accordance with the present invention is suitable for a navigation device which uses map data managed by a map data supplier by using a general-purpose software library provided by the map data supplier.

1. A software library reconstruction device comprising:
a function executing unit for executing a function specified from among a plurality of functions by using a general-purpose software library corresponding to said plurality of functions;
a program extracting unit for extracting program elements which are used for the execution of said function by said function executing unit from among program elements which construct said general-purpose software library;
a program verifying unit for verifying whether or not an error is found in each of the program elements extracted by said program extracting unit;
a program optimizing unit for optimizing a program comprised of program elements each of which said program verifying unit has verified does not have any error; and
a program reconstructing unit for constructing a software library which is customized to said function executed by said function executing unit by using the program elements of said program which is optimized by said program optimizing unit.

2. The software library reconstruction device according to claim 1, wherein said function executing unit executes said function on a specified execution condition by using the software library which is customized to said function, said program extracting unit extracts program elements which are used for the execution of said function by said function executing unit from among the program elements which construct the software library which is customized to said function, said program verifying unit verifies whether or not an error is found in each of the program elements extracted by said program extracting unit, said program optimizing unit optimizes a program which is comprised of program elements each of which said program verifying unit has verified does not have any error, and said program reconstructing unit constructs a software library in which said function is limited by said execution condition by using the program element of said program which is optimized by said program optimizing unit.

3. The software library reconstruction device according to claim 1, wherein said software library reconstruction device includes a usage characteristics determining unit for acquiring an execution condition which a user specifies for said function every time when said function executing unit executes said unction, and for performing a statistical process on said acquired execution condition to determine an execution condition for said function according to a usage characteristics of said user, and wherein said program optimizing unit optimizes the program which is comprised of program elements each of which said program verifying unit has verified does not have any error by using said execution condition determined by said usage characteristics determining unit, and said program reconstructing unit constructs a software library in which said function is limited by said execution condition determined by said usage characteristics determining unit by using the program elements of said program which is optimized by said program optimizing unit.

4. The software library reconstruction device according to claim 1, wherein each of said function executing unit, said program verifying unit, said program optimizing unit, and said program reconstructing unit interactively inquires of a user about information required to carry out its own process in a wizard form, and carries out said its own process by using the information required to carry out said its own process which is inputted by said user.

5. The software library reconstruction device according to claim 1, wherein each of said function executing unit, said program verifying unit, said program optimizing unit, and said program reconstructing unit carries out its own process automatically by using preset information required to carry out said its own process.

6. A software library reconstruction method for use in a software library reconstruction device equipped with a function executing unit, a program extracting unit, a program verifying unit, a program optimizing unit, and a program reconstructing unit, said software library reconstruction method comprising:
a step of said function executing unit executing a function specified from among a plurality of functions by using a general-purpose software library corresponding to said plurality of functions;
a step of said program extracting unit extracting program elements which are used for the execution of said function by said function executing unit from among program elements which construct said general-purpose software library;
a step of said program verifying unit verifying whether or not an error is found in each of the program elements extracted by said program extracting unit;
a step of said program optimizing unit optimizing a program which is comprised of program elements each of which said program verifying unit has verified does not have any error; and
a step of said program reconstructing unit constructing a software library which is customized to said function executed by said function executing unit by using the program elements of said program which is optimized by said program optimizing unit.

7. A navigation device having a navigation function of searching for a route from a departure point to a destination point, and performing route guidance, said navigation device comprising:
a function executing unit for executing a function specified from among a plurality of functions related to said navigation function by using a general-purpose software library corresponding to said plurality of functions;
a program extracting unit for extracting program elements which are used for the execution of said function by said function executing unit from among program elements which construct said general-purpose software library;
a program verifying unit for verifying whether or not an error is found in each of the program elements extracted by said program extracting unit;
a program optimizing unit for optimizing a program which is comprised of program elements each of which said program verifying unit has verified does not have any error; and
a program reconstructing unit for constructing a software library which is customized to said function executed by said function executing unit by using the program elements of said program which is optimized by said program optimizing unit.
